(19) United States
(12) Patent Application Publication
(10) Pub. No.: US 2026/0237916 A1
(43) Pub. Date: Aug. 13, 2026

(54) Removable Grounding Clip

(71) Applicant: Illinois Tool Works Inc., Glenview, IL (US)

(72) Inventors: Kathryn G. Bailey, Farmington, MI (US); Victoria G. Brender, Gaylord, MI (US)

(21) Appl. No.: 19/532,702

(22) Filed: Feb. 6, 2026

Related U.S. Application Data
(60) Provisional application No. 63/757,856, filed on Feb. 13, 2025.

(51) Int. Cl. H01R 4/2404; H01R 13/11; H01R 13/627; H01R 13/631

(52) U.S. Cl. CPC H01R 4/2404; H01R 13/113; H01R 13/6275; H01R 13/631

(57) ABSTRACT

Described is a removable grounding clip for mechanically and electrically coupling a first component and a second component. The clip includes a stamped metal body defining a channel configured to receive edges of the components. At least one clip feature is configured to engage an opening in the components for retention. At least one barb projects into the channel to disrupt surface coatings and establish electrical contact with the first component and the second component. The clip is resiliently biased to apply a clamping force, is removable without permanent deformation, and can include features such as down-turned tabs or window-supported clip features to facilitate installation, retention, and grounding.

### RELATED APPLICATIONS

The present application claims priority to U.S. Provisional Patent Application No. 63/757,856, filed Feb. 13, 2025, and entitled “Removable Grounding Clip,” which is hereby incorporated by reference in its entirety.

### BACKGROUND

Automotive components require fastening techniques that are simple to manufacture and assemble. Further, fastening techniques should above all be reliable and efficient.

Electrical grounding is used to establish a reference potential for electrical systems and to provide a return path for electrical current. In many electrical and electromechanical systems, a ground potential is defined as a reference node against which other voltages are measured. Components that share a common ground are electrically coupled to ensure proper operation, signal integrity, and safety.

In vehicles and other complex assemblies, multiple components and subsystems may be mounted to different structural members, panels, or frames. These components often require both a reliable electrical ground connection and a secure mechanical attachment. In automotive, aerospace, industrial, and consumer applications, conductive structural elements such as frames, chassis members, or panels are commonly used as ground paths. As a result, electrical grounding is frequently achieved by electrically connecting separate components or panels to one another and to a common conductive structure.

Conventional grounding techniques often rely on discrete ground straps, wires, or cables that are terminated using fasteners, welds, or crimped connectors. While effective, such approaches can increase part count, assembly time, and manufacturing complexity. In addition, ground straps and wires may be susceptible to loosening, corrosion, vibration-induced fatigue, or inconsistent electrical contact over time, particularly in environments subject to thermal cycling, moisture, or mechanical vibration.

In some assemblies, it is desirable to electrically ground adjacent components or panels directly to one another while simultaneously providing a mechanical retention function. Achieving both reliable electrical continuity and robust mechanical engagement can be challenging, especially when components are manufactured with coatings, surface treatments, or dimensional tolerances that may interfere with consistent electrical contact.

Accordingly, there is a continued need for grounding solutions that provide both secure mechanical attachment and reliable electrical connectivity between components, while reducing assembly complexity, improving durability, and maintaining consistent grounding performance over the life of the assembly.

### SUMMARY

The present disclosure relates generally to a grounding clip to form a connection, including an electrical connection, between two components, such as vehicular components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an underside isometric assembled view of a fastening system with a removable grounding clip, in accordance with an aspect of this disclosure.

FIG. 1b illustrates a side elevation assembly view of the fastening system.

FIG. 1c illustrates a side elevation assembled view of the fastening system.

FIG. 2a illustrates a first topside isometric view of the removable grounding clip for FIGS. 1a through 1c.

FIG. 2b illustrates a second topside isometric view of the removable grounding clip.

FIG. 2c illustrates an elevation view of a first side of the removable grounding clip.

FIG. 2d illustrates an elevation view of a second side of the removable grounding clip.

FIG. 2e illustrates a top plan view of the removable grounding clip.

FIG. 2f illustrates a bottom plan view of the removable grounding clip.

FIG. 2g illustrates an elevation view of a rear side of the removable grounding clip.

FIG. 2h illustrates an elevation view of a front side of the removable grounding clip.

FIG. 3a illustrates a first topside isometric view of the removable grounding clip in accordance with another aspect of this disclosure.

FIG. 3b illustrates a second topside isometric view of the removable grounding clip.

FIG. 3c illustrates an elevation view of a first side of the removable grounding clip.

FIG. 3d illustrates an elevation view of a second side of the removable grounding clip.

FIG. 3e illustrates a top plan view of the removable grounding clip.

FIG. 3f illustrates a bottom plan view of the removable grounding clip.

FIG. 3g illustrates an elevation view of a rear side of the removable grounding clip.

FIG. 3h illustrates an elevation view of a front side of the removable grounding clip.

FIG. 4a illustrates a first topside isometric view of the removable grounding clip in accordance with yet another aspect of this disclosure.

FIG. 4b illustrates a second topside isometric view of the removable grounding clip.

FIG. 4c illustrates an elevation view of a first side of the removable grounding clip.

FIG. 4d illustrates an elevation view of a second side of the removable grounding clip.

FIG. 4e illustrates a top plan view of the removable grounding clip.

FIG. 4f illustrates a bottom plan view of the removable grounding clip.

FIG. 4g illustrates an elevation view of a rear side of the removable grounding clip.

FIG. 4h illustrates an elevation view of a front side of the removable grounding clip.

FIG. 5a illustrates a first topside isometric view of the removable grounding clip in accordance with yet another aspect of this disclosure.

FIG. 5b illustrates a second topside isometric view of the removable grounding clip.

FIG. 5c illustrates an elevation view of a first side of the removable grounding clip.

FIG. 5d illustrates an elevation view of a second side of the removable grounding clip.

FIG. 5e illustrates a top plan view of the removable grounding clip.

FIG. 5f illustrates a bottom plan view of the removable grounding clip.

FIG. 5g illustrates an elevation view of a rear side of the removable grounding clip.

FIG. 5h illustrates an elevation view of a front side of the removable grounding clip.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a grounding clip to form a connection between two components, such as vehicular components. For example, the grounding clip is configured to form both a physical connection and an electrical connection between the two components.

In one example, a grounding clip configured to electrically and mechanically couple a first component and a second component comprises: a body portion defining a channel configured to receive an edge region of the first component and the second component; a first planar portion and a second planar portion spaced apart to define the channel and resiliently biased toward one another to apply a clamping force; at least one grounding feature configured to establish electrical continuity between the body portion and the first component or the second component; and at least one clip feature configured to engage an opening formed in at least one of the first component or the second component to retain the grounding clip in an installed position.

In some examples, the grounding clip is removable without permanent deformation.

In some examples, the at least one grounding feature configured to disrupt a surface coating on at least one of the first component or the second component.

In some examples, the at least one grounding feature comprises a barb formed in at least one of the first planar portion or the second planar portion.

In some examples, the channel is generally U-shaped and configured to receive overlapping edge portions of the first component and the second component.

In some examples, the body portion has a width, a depth, and a height, and wherein the width is at least three times the depth.

In some examples, the first planar portion and the second planar portion are resiliently connected by an integral spring bend.

In some examples, the at least one clip feature comprises two spaced-apart clip features positioned along a width of the body portion.

In some examples, the clip features are configured to provide a snap-fit engagement with the opening.

In some examples, each clip feature comprises a down-turned tab extending from the body portion.

In some examples, the down-turned tab is oriented substantially perpendicular to the first planar portion.

In some examples, the down-turned tab includes a sloped leading edge configured to guide the down-turned tab into the opening during installation.

In some examples, each clip feature is formed within a cutout window in the first planar portion.

In some examples, each clip feature is connected to the body portion at opposite ends.

In some examples, the barb and the at least one clip feature are aligned along a depth of the body portion.

In another example, a stamped metal retainer comprises: a unitary metal body having a first planar portion and a second planar portion spaced apart and resiliently connected to define a channel configured to receive an edge of at least one panel; at least one clip feature formed integrally with the unitary metal body and configured to engage an opening in the panel to mechanically retain the stamped metal retainer on the panel; and at least one barb formed integrally with the unitary metal body and projecting into the channel, wherein the at least one barb is configured to disrupt a surface coating on the panel to establish electrical contact between the stamped metal retainer and the panel.

In some examples, the at least one clip feature comprises two spaced-apart clip features positioned along a width of the unitary metal body.

In some examples, each of the two spaced-apart clip features includes a down-turned tab oriented substantially perpendicular to the first planar portion.

In some examples, the at least one clip feature is formed within a cutout window in the first planar portion of the unitary metal body and is connected to the unitary metal body at opposite ends.

In some examples, the at least one barb and the at least one clip feature are aligned along a depth of the unitary metal body.

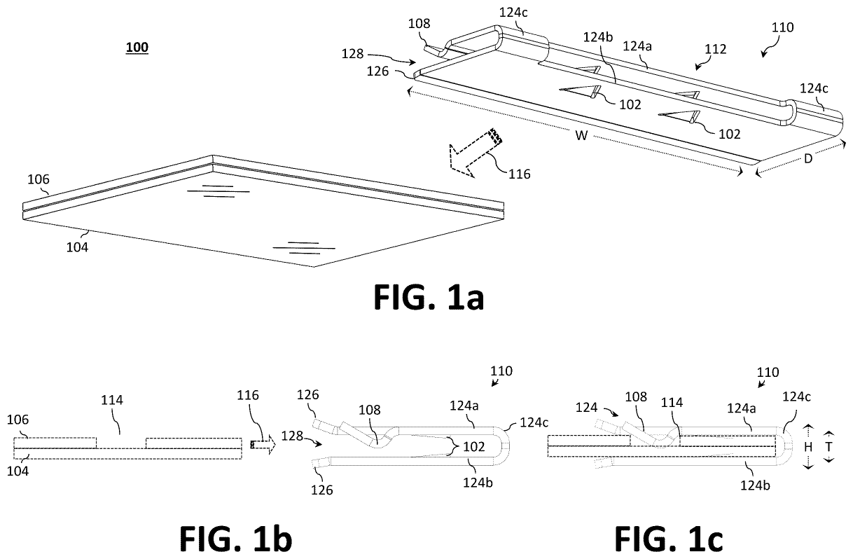

FIGS. 1a through 1c illustrate an example of a fastening system 100 including a removable grounding clip 110. FIG. 1a illustrates an underside isometric assembled view of the fastening system 100, FIG. 1b illustrates a side elevation assembly view of the fastening system 100, and FIG. 1c illustrates a side elevation assembled view of the fastening system 100. The fastening system 100 includes a first component 104, a second component 106, and the removable grounding clip 110. The removable grounding clip 110 is configured to mechanically join the first component 104 and the second component 106, while simultaneously providing electrical conductivity between the components.

In one non-limiting example, the first component 104 and the second component 106 are electrocoated (e-coated) metal panels. The removable grounding clip 110 functions to electrically ground the first component 104 to the second component 106 by locally disrupting the e-coat layer, such as by scraping, cutting, or gouging through the coating, to establish metal-to-metal contact and thereby facilitate electrical continuity. In addition to providing electrical grounding, the removable grounding clip 110 physically maintains the first component 104 and the second component 106 in a closed or clamped condition along one or more edges, for example during a sealant curing process.

The removable grounding clip 110 can be further configured to allow limited floating or positional tolerance along the panels, which facilitates ease of installation and enables automated or robotic assembly processes.

To facilitate attachment via the removable grounding clip 110, each of the first component 104 and/or the second component 106 may include one or more engagement features. In the illustrated example, the first component 104 includes an opening 114 formed therein. Although not shown, the second component 106 may alternatively or additionally include similar openings configured to receive corresponding features of the removable grounding clip 110.

In the illustrated example, the opening 114 is quadrilateral in shape; however, other shapes and geometries are contemplated. The opening 114 is configured to receive and engage clip features 108 formed on the removable grounding clip 110, thereby retaining the clip in position relative to the first component 104. The removable grounding clip 110 provides positive engagement feedback during installation, such as an audible or tactile click upon engagement between the opening 114 and the clip features 108, ensuring proper placement and retention without requiring complex alignment procedures.

The openings, such as opening 114, may be formed during manufacture of the first component 104 or the second component 106, or may be added post-manufacture using a mechanical process such as drilling, cutting, stamping, or carving. As best illustrated in FIG. 1c, when the first component 104 and the second component 106 are assembled, the second component 106 at least partially overlaps or covers the first component 104, and both components are received within the removable grounding clip 110.

The removable grounding clip 110 includes one or more grounding features, such barbs 102. The barbs 102 are illustrated as triangular barbs in the figures; however, the barbs may take any suitable shape or form. The barbs 102 are positioned on upper and lower portions of the removable grounding clip 110 and are configured to penetrate or scratch through the e-coat layers on the first component 104 and the second component 106. This action establishes a reliable electrical grounding path between the two components through the removable grounding clip 110.

A guide lip 126 is provided on both the top and bottom portions of the removable grounding clip 110 (e.g., at the edges of the opposing first and second planar portions 124a and 124b). The guide lip 126 assists in guiding a channel 128 of the removable grounding clip 110 during installation and helps align the removable grounding clip 110 around the first component 104 and the second component 106. The removable grounding clip 110 further includes two clip features 108, which may vary in shape, size, and design across different examples, for engaging with the opening 114 in the first component 104 and/or the second component 106.

A removal tool may be used to engage the clip features 108 and/or the barbs 102 to elastically deform or wedge open the removable grounding clip 110, thereby allowing the clip to be removed from the first component 104 and the second component 106 without permanent deformation or damage.

With reference to FIG. 1a, the removable grounding clip 110 has a width (W), a depth (D), and a height (H). In one example, the width (W) is approximately three to four times the depth (D), although other dimensional ratios are contemplated. The height (H) is determined by the combined thickness of the first component 104, the second component 106, and the material thickness, such as metal gauge, of the removable grounding clip 110 itself.

This dimensional configuration provides a relatively large surface area, allowing the removable grounding clip 110 to clamp over an extended distance along the edges of the first component 104 and the second component 106. This enhances mechanical retention while simultaneously improving electrical grounding performance through multiple contact points, including the barbs 102.

The removable grounding clip 110 may include additional points or features of securement to ensure positive engagement with the first component 104 and the second component 106. Examples of such features include additional barbs, spring elements, detents, or engagement structures configured to enhance retention, grounding reliability, or ease of installation and removal.

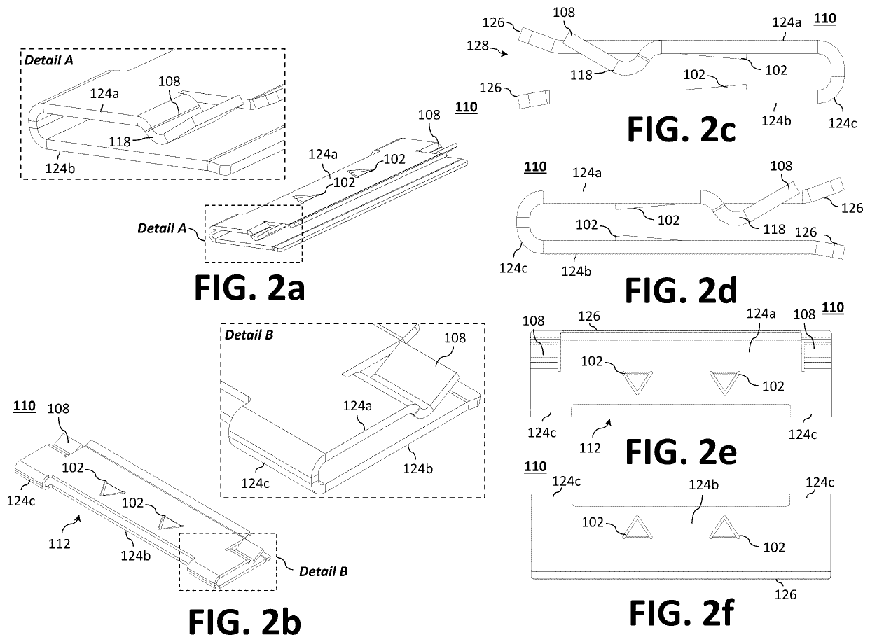

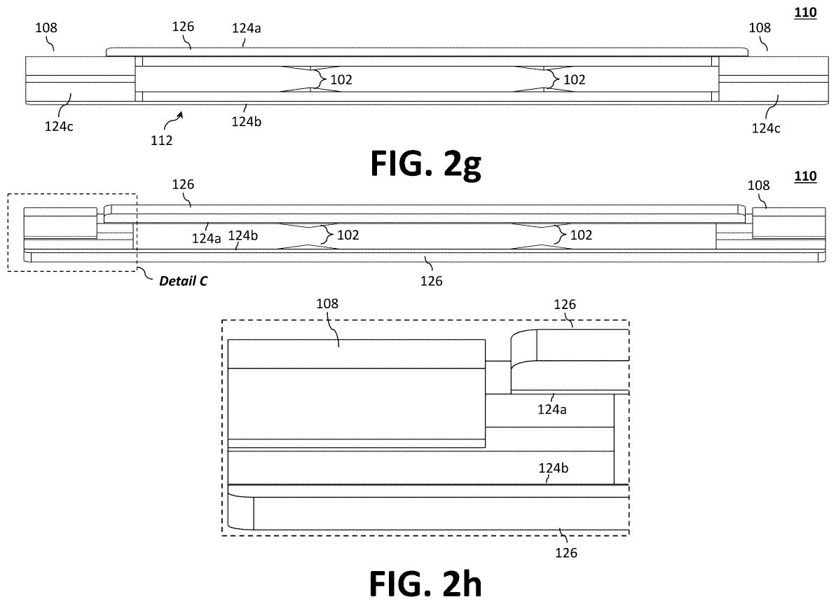

FIGS. 2a through 2h illustrate various views of the removable grounding clip 110. FIG. 2a illustrates a first topside isometric view of the removable grounding clip 110 associated with the fastening system 100 of FIGS. 1a through 1c. FIG. 2b illustrates a second topside isometric view of the removable grounding clip 110. FIGS. 2c and 2d illustrate elevation views of first and second sides of the removable grounding clip 110, respectively. FIG. 2e illustrates a top plan view, FIG. 2f illustrates a bottom plan view, FIG. 2g illustrates an elevation view of a rear side, and FIG. 2h illustrates an elevation view of a front side of the removable grounding clip 110.

The removable grounding clip 110 comprises a body portion 124. The removable grounding clip 110 is configured to mechanically engage and couple with the first component 104 via the opening 114.

The removable grounding clip 110 may be fabricated as a stamped-metal component using a metal-stamping technique. For example, the removable grounding clip 110 may be fabricated from a single sheet of metal that is stamped and bent into a desired configuration. In other examples, the removable grounding clip 110 may be fabricated using material extrusion or additive manufacturing techniques, including but not limited to fused deposition modeling (FDM), stereolithography (SLA), selective laser sintering (SLS), material jetting, binder jetting, powder bed fusion, directed energy deposition, or VAT photopolymerisation.

The first component 104 and the second component 106 may be automotive panels or other automotive components. Depending on the application, one or both of the first component 104 and the second component 106 may be fabricated from metal or metal alloys, synthetic or semi-synthetic polymers such as plastics including acrylonitrile butadiene styrene (ABS) or polyvinyl chloride (PVC), composite materials such as fiberglass, or combinations thereof. In instances where the first component 104 and the second component 106 are electrically conductive, the components may be made from conductive metals or metal alloys, or may include electrically conductive material added to polymers or composite materials.

In the automotive industry, example first components 104 and second components 106 include, without limitation, door trim panels, moldings, trim pieces, automotive panels, structural components such as doors, pillars including A-pillars, B-pillars, and C-pillars, dashboard components such as cross members, brackets, or frames, seat frames, center consoles, fenders, sheet metal framework, or the like.

During installation, as best illustrated in FIGS. 1a and 1b, the removable grounding clip 110 is slipped onto an edge of the first component 104 as indicated by arrow 116. The removable grounding clip 110 is configured to engage the first component 104 with a snap-fit or interference fit to retain itself in position.

Accordingly, the opening 114 is sized and shaped to receive and retain the clip features 108. In the illustrated example, the opening 114 is generally quadrilateral but may optionally include chamfers, fillets, or other features to facilitate centering and insertion. A portion of the first component 104 is clamped or sandwiched between opposing portions of the removable grounding clip 110.

The removable grounding clip 110 comprises a body portion 124 that defines a channel 128, such as a generally U-shaped channel, dimensioned to receive and retain portions of the first component 104 and the second component 106. The body portion 124 is formed as a pair of opposing first and second planar portions 124a and 124b, which are resiliently connected by an integral spring bend 124c, such as a U-bend. As illustrated, the integral spring bend 124c can be a pair of spaced apart integral spring bends 124c (illustrate with two integral spring bends 124c) with a gap 112 positioned therebetween to reduce material usage, weight, and to provide a desired clamping strength provided by the integral spring bend(s) 124c.

The planar portions 124a and 124b exert a clamping force on the first component 104 upon insertion into the channel 128, thereby providing mechanical retention. The planar portions are configured to default to a predetermined unstressed shape.

The second planar portion 124b is stamped and bent to form the channel 128, the barbs 102, and the clip features 108. The clip features 108 are resiliently coupled to the first planar portion 124a at opposite ends along the width (W) of the removable grounding clip 110. The barbs 102 are stamped in the first planar portion 124a and/or the second planar portion 124b. In this example, each of the clip features 108 is shaped as a spring clip or spring tab with a protrusion 118 that snaps into, for example, the opening 114 when assembled. In this example, the clip features 108 are connected at just one end (e.g., it is cantilevered) and positioned at the corners of the first planar portion 124a.

With reference to FIG. 1c, the first planar portion 124a and the second planar portion 124b are arranged substantially parallel to one another and are spaced apart to define the channel 128. The channel 128 is dimensioned to accommodate the thicknesses (T) of the first component 104 and the second component 106 while maintaining sufficient clamping force to ensure mechanical retention and electrical grounding. In the example of FIGS. 2a through 2h, a set of two barbs 102 is positioned in or on each of the first planar portion 124a and the second planar portion 124b along the width (W) and generally positioned between the two illustrated spaced-apart clip features 108.

The various features of the removable grounding clip 110 may be stamped, punched, coined, and/or extruded from the material of the body portion 124 and subsequently bent into final shape through forming operations to produce a structurally integral and dimensionally stable removable grounding clip 110 optimized for high-volume manufacturing.

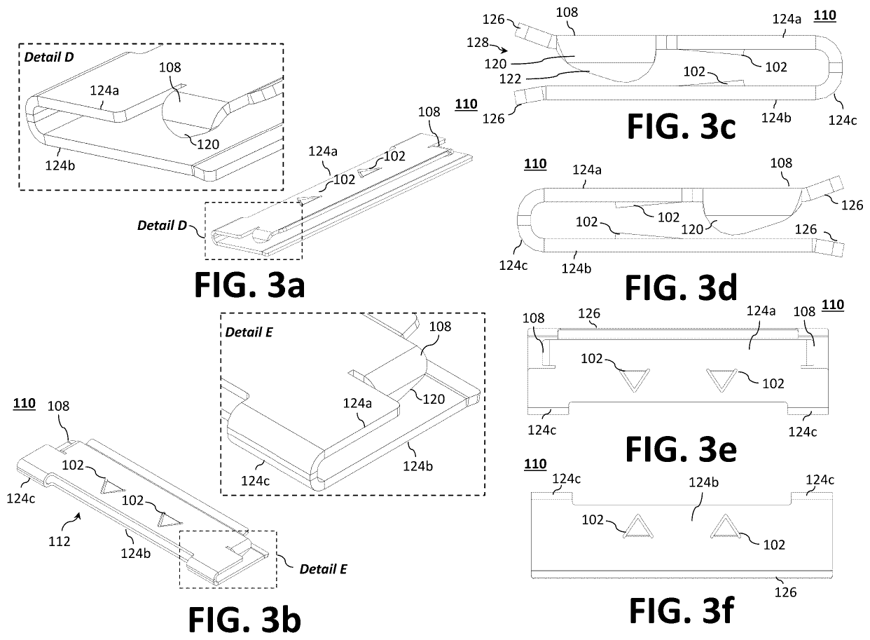

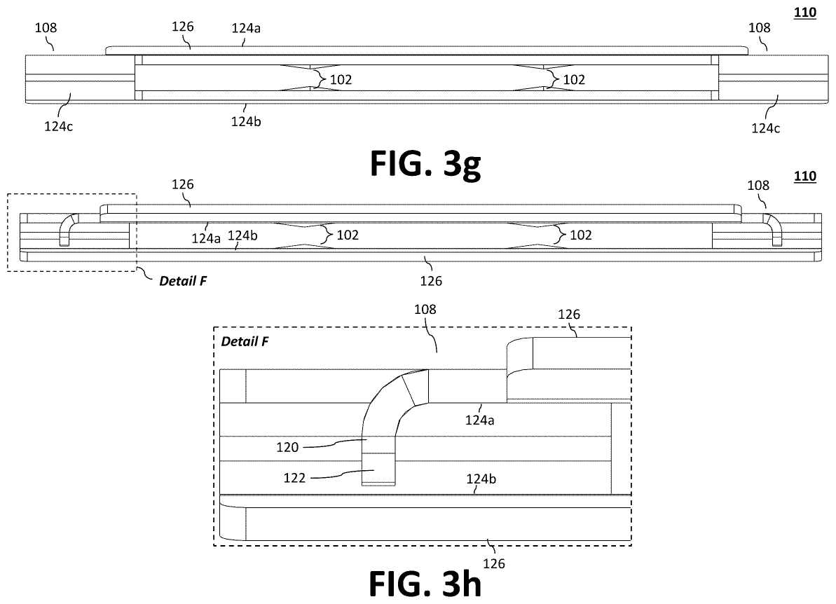

FIGS. 3a through 3h illustrate views of a removable grounding clip 110 in accordance with another aspect of this disclosure. FIG. 3a illustrates a first topside isometric view of the removable grounding clip 110. FIG. 3b illustrates a second topside isometric view of the removable grounding clip 110. FIG. 3c illustrates an elevation view of a first side of the removable grounding clip 110. FIG. 3d illustrates an elevation view of a second side of the removable grounding clip 110. FIG. 3e illustrates a top plan view of the removable grounding clip 110. FIG. 3f illustrates a bottom plan view of the removable grounding clip 110. FIG. 3g illustrates an elevation view of a rear side of the removable grounding clip 110. FIG. 3h illustrates an elevation view of a front side of the removable grounding clip 110. The removable grounding clip 110 of FIGS. 3a through 3h is substantially the same as the removable grounding clip 110 described with respect to FIGS. 1a through 2h, and therefore only the differences will be emphasized, as the remaining components and features are the same.

In this example, the two spaced-apart clip features 108 each include a down-turned tab 120 configured to engage the opening 114 formed in the first component 104 and/or the second component 106. The down-turned tab 120 is formed as a generally planar tab oriented substantially perpendicular to the first planar portion 124a of the body portion 124. This perpendicular orientation increases engagement depth within the opening 114 and enhances resistance to withdrawal forces acting in a direction opposite installation.

As best illustrated in FIG. 3c, the leading edge 122 of the down-turned tab 120 is sloped or chamfered. The sloped leading edge 122 functions as a lead-in surface that guides the down-turned tab 120 over an edge of the first and/or second components 104, 106 and into alignment with the opening 114 during installation. This geometry reduces insertion force, mitigates the risk of panel damage, and improves installation repeatability, particularly in automated or robotic assembly environments. Once inserted, the down-turned tab 120 resists disengagement by providing a positive mechanical stop against the perimeter of the opening 114.

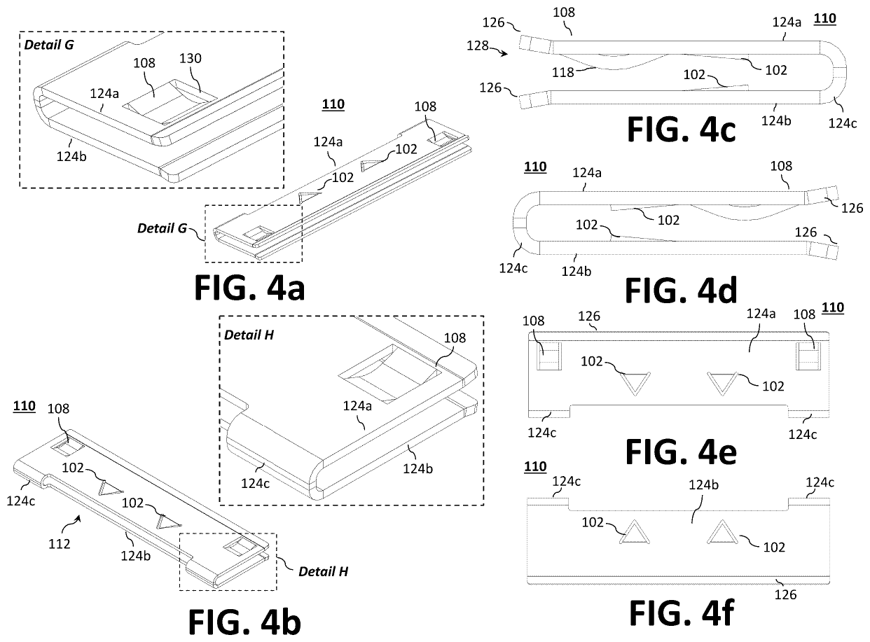

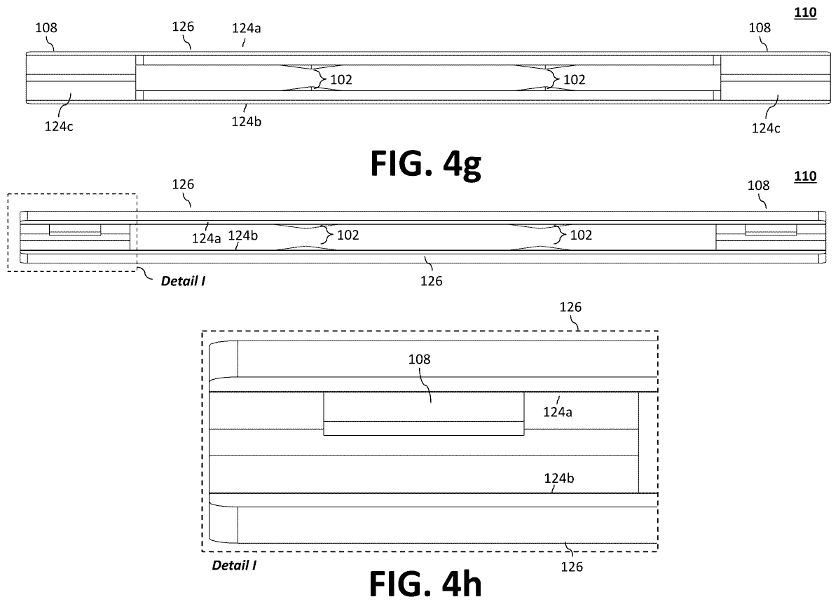

FIGS. 4a through 4h illustrate views of a removable grounding clip 110 in accordance with yet another aspect of this disclosure. FIG. 4a illustrates a first topside isometric view of the removable grounding clip 110. FIG. 4b illustrates a second topside isometric view of the removable grounding clip 110. FIG. 4c illustrates an elevation view of a first side of the removable grounding clip 110. FIG. 4d illustrates an elevation view of a second side of the removable grounding clip 110. FIG. 4e illustrates a top plan view of the removable grounding clip 110. FIG. 4f illustrates a bottom plan view of the removable grounding clip 110. FIG. 4g illustrates an elevation view of a rear side of the removable grounding clip 110. FIG. 4h illustrates an elevation view of a front side of the removable grounding clip 110. The removable grounding clip 110 of FIGS. 4a through 4h is substantially the same as the removable grounding clip 110 described with respect to FIGS. 1a through 2h, and therefore only the differences will be emphasized, as the remaining components and features are the same.

In this example, the clip features 108 define a protrusion 118 similar in function to that described with respect to FIGS. 2a through 2h; however, unlike a cantilevered configuration, each clip feature 108 is connected at opposite ends to the body portion 124. More specifically, each clip feature 108 is positioned within, and formed from, a cutout window 130 located at or adjacent to the corners of the first planar portion 124a.

This non-cantilevered, window-supported configuration can increase structural stiffness of the clip features 108 and distributes engagement forces into the surrounding material of the body portion 124. The cutout window 130 further provides controlled compliance, allowing the clip feature 108 to elastically deflect during insertion while maintaining a robust mechanical interlock once seated.

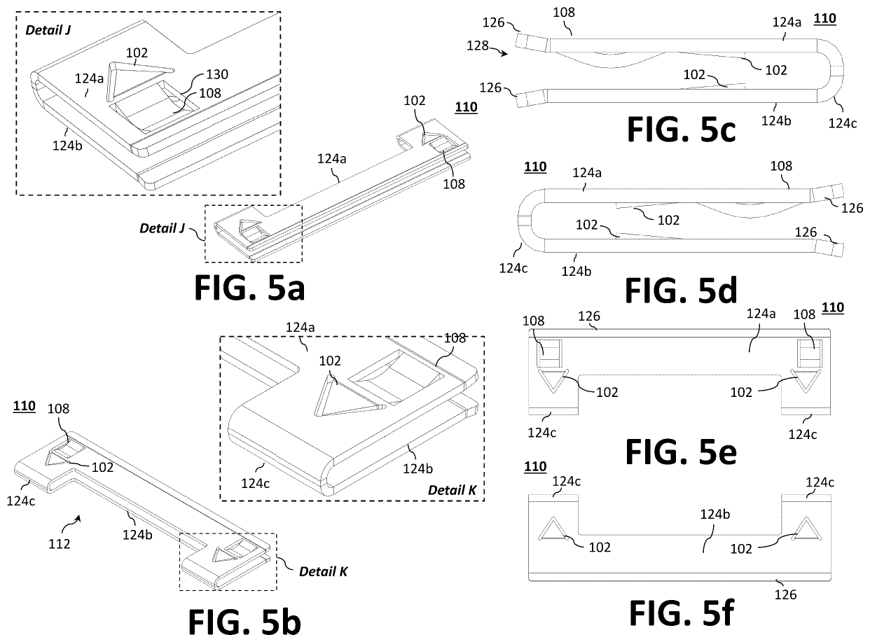

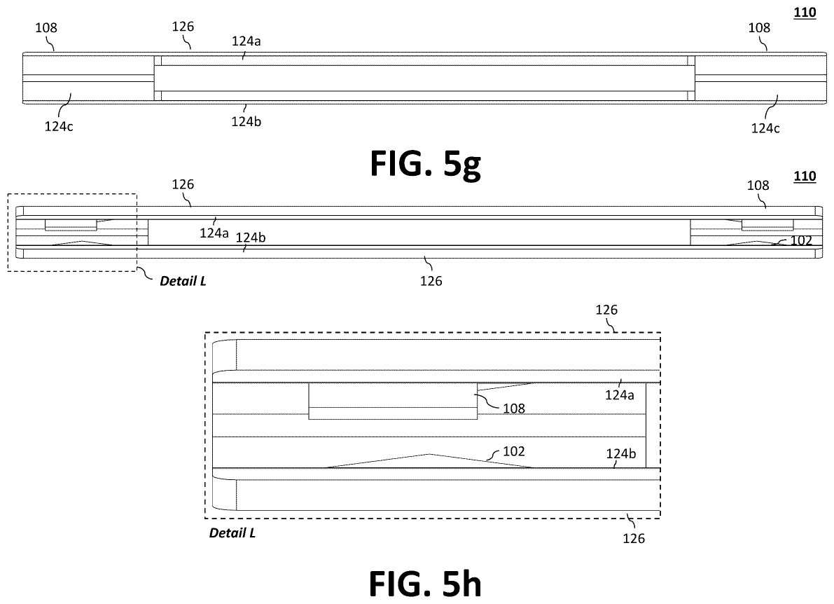

FIGS. 5a through 5h illustrate views of a removable grounding clip 110 in accordance with yet another aspect of this disclosure. FIG. 5a illustrates a first topside isometric view of the removable grounding clip 110. FIG. 5b illustrates a second topside isometric view of the removable grounding clip 110. FIG. 5c illustrates an elevation view of a first side of the removable grounding clip 110. FIG. 5d illustrates an elevation view of a second side of the removable grounding clip 110. FIG. 5e illustrates a top plan view of the removable grounding clip 110. FIG. 5f illustrates a bottom plan view of the removable grounding clip 110. FIG. 5g illustrates an elevation view of a rear side of the removable grounding clip 110. FIG. 5h illustrates an elevation view of a front side of the removable grounding clip 110. The removable grounding clip 110 of FIGS. 5a through 5h is substantially the same as the removable grounding clip 110 described with respect to FIGS. 1a through 2h, and therefore only the differences will be emphasized, as the remaining components and features are the same.

In this example, the clip features 108 are substantially similar to those described with respect to FIGS. 4a through 4h; however, the spatial arrangement of the clip features 108 relative to the barbs 102 is changed. Specifically, the clip features 108 and the barbs 102 are aligned along the depth (D) of the removable grounding clip 110, rather than the barbs 102 being positioned between the clip features 108 along the width (W).

By relocating the barbs 102 along the depth (D), the lateral footprint of the removable grounding clip 110 is reduced, allowing the size of the first planar portion 124a and the second planar portion 124b to be correspondingly reduced. This configuration minimizes material usage and overall component weight while maintaining sufficient clamping force and electrical grounding performance. Additionally, the reduced planar size enables an increase in the size of the gap 112, including an increased degree of extension into the first planar portion 124a and the second planar portion 124b, as best illustrated in FIGS. 5b, 5e, and 5f.

The enlarged gap 112 can affect elastic compliance of the clip features 108 during installation and removal, which can improve manufacturability through stamping operations, and allow for finer tuning of retention force without increasing material thickness. This example therefore provides a favorable balance between mechanical retention, electrical grounding reliability, material efficiency, and manufacturability.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A grounding clip configured to electrically and mechanically couple a first component and a second component, the grounding clip comprising:
a body portion defining a channel configured to receive an edge region of the first component and the second component;
a first planar portion and a second planar portion spaced apart to define the channel and resiliently biased toward one another to apply a clamping force;
at least one grounding feature configured to establish electrical continuity between the body portion and the first component or the second component; and
at least one clip feature configured to engage an opening formed in at least one of the first component or the second component to retain the grounding clip in an installed position.

2. The grounding clip of claim 1, wherein the grounding clip is removable without permanent deformation.

3. The grounding clip of claim 1, wherein the at least one grounding feature configured to disrupt a surface coating on at least one of the first component or the second component.

4. The grounding clip of claim 1, wherein the at least one grounding feature comprises a barb formed in at least one of the first planar portion or the second planar portion.

5. The grounding clip of claim 1, wherein the channel is generally U-shaped and configured to receive overlapping edge portions of the first component and the second component.

6. The grounding clip of claim 1, wherein the body portion has a width, a depth, and a height, and wherein the width is at least three times the depth.

7. The grounding clip of claim 1, wherein the first planar portion and the second planar portion are resiliently connected by an integral spring bend.

8. The grounding clip of claim 1, wherein the at least one clip feature comprises two spaced-apart clip features positioned along a width of the body portion.

9. The grounding clip of claim 8, wherein the clip features are configured to provide a snap-fit engagement with the opening.

10. The grounding clip of claim 8, wherein each clip feature comprises a down-turned tab extending from the body portion.

11. The grounding clip of claim 10, wherein the down-turned tab is oriented substantially perpendicular to the first planar portion.

12. The grounding clip of claim 10, wherein the down-turned tab includes a sloped leading edge configured to guide the down-turned tab into the opening during installation.

13. The grounding clip of claim 8, wherein each clip feature is formed within a cutout window in the first planar portion.

14. The grounding clip of claim 13, wherein each clip feature is connected to the body portion at opposite ends.

15. The grounding clip of claim 4, wherein the barb and the at least one clip feature are aligned along a depth of the body portion.

16. A stamped metal retainer comprising:
a unitary metal body having a first planar portion and a second planar portion spaced apart and resiliently connected to define a channel configured to receive an edge of at least one panel;
at least one clip feature formed integrally with the unitary metal body and configured to engage an opening in the panel to mechanically retain the stamped metal retainer on the panel; and
at least one barb formed integrally with the unitary metal body and projecting into the channel,
wherein the at least one barb is configured to disrupt a surface coating on the panel to establish electrical contact between the stamped metal retainer and the panel.

17. The stamped metal retainer of claim 16, wherein the at least one clip feature comprises two spaced-apart clip features positioned along a width of the unitary metal body.

18. The stamped metal retainer of claim 17, wherein each of the two spaced-apart clip features includes a down-turned tab oriented substantially perpendicular to the first planar portion.

19. The stamped metal retainer of claim 16, wherein the at least one clip feature is formed within a cutout window in the first planar portion of the unitary metal body and is connected to the unitary metal body at opposite ends.

20. The stamped metal retainer of claim 16, wherein the at least one barb and the at least one clip feature are aligned along a depth of the unitary metal body.
